(19) United States
(12) Patent Application Publication
(10) Pub. No.: US 2021/0229180 A1
(43) Pub. Date: Jul. 29, 2021

(54) SELECTIVELY DEPOSITING MATERIAL

(71) Applicant: HEWLETT-PACKARD DEVELOPMENT COMPANY, L.P., Spring, TX (US)

(72) Inventors: Mohammad Jowkar, Sant Cugat del Valles (ES); Rhys Mansell, Sant Cugat del Valles (ES); Vicente Granados Asensio, Sant Cugat del Valles (ES)

(73) Assignee: HEWLETT-PACKARD DEVELOPMENT COMPANY, L.P., SPRING, TX (US)

(21) Appl. No.: 17/050,614

(22) PCT Filed: Oct. 16, 2018
(86) PCT No.: PCT/US2018/056022

§ 371 Date: Oct. 26, 2020

(51) Int. Cl. B22F 10/14; B22F 12/53; B22F 12/30; B33Y 30/00; B22F 1/00; B33Y 50/02; B22F 12/55; B22F 12/00; B33Y 10/00; B22F 10/85

(52) U.S. Cl. CPC B22F 10/14; B22F 12/53; B22F 12/30; B33Y 30/00; B22F 10/85; B33Y 50/02; B22F 12/55; B22F 12/224; B33Y 10/00; B22F 1/0059

(57) ABSTRACT

In an example, a method comprises controlling material dispensing by a material dispensing apparatus to output a layer of material onto a build platform. The material dispensing apparatus comprises a plurality of pairs of material containers, each pair of material containers movable along a path across the build platform, and comprising a first material container to dispense a first material and a second material container to dispense a second material, to output a band of material along the path, each pair of material containers being arranged with respect to each other pair of material containers to move along respective paths across the build platform to output respective bands of material forming a complete layer of material on the build platform. The controlling comprises controlling each pair of material containers to move along its respective path and deposit, selectively, first material, along one or more regions of the respective band along the respective path that coincide with a portion of a part to be printed, and deposit, selectively, second material, along other regions of the respective band along the respective path.

### BACKGROUND

Certain printing systems make use of a powdered or particulate build material during a printing process. For example, an additive manufacturing system, such as a three-dimensional (3D) printing system, may use an apparatus to convey build material onto a build platform. The powdered build material may be used by the system to form a 3D printed part on the build platform, such as by fusing particles of build material in layers, whereby the printed part is generated on a layer-by-layer basis.

### BRIEF DESCRIPTION OF THE DRAWINGS

Various features and advantages of the present disclosure will be apparent from the detailed description which follows, taken in conjunction with the accompanying drawings, which together illustrate, by way of example only, features of the present disclosure, and wherein:

FIG. 1 is a flow diagram of a method according to an example;

FIG. 2 is a flow diagram of a method according to an example;

FIG. 3 is a flow diagram of a method according to an example;

FIG. 4 is a flow diagram of a method according to an example;

FIGS. 5a-8b are schematic plan views of a layer of a 3D build volume before during and after a method according to an example;

FIG. 9 is a schematic plan view of a material dispensing apparatus according to an example;

FIG. 10 is schematic isometric view of a plurality of pairs of material containers according to an example; and

FIG. 11 is a schematic view of a system according to an example.

### DETAILED DESCRIPTION

3D printed parts can be generated using additive manufacturing techniques. The printed parts may be generated by solidifying portions of successive layers of build material. The build material can be powder-based, and the material properties of generated printed parts may be dependent on the type of build material and the nature of the solidification process. In some examples, solidification of the powder material is enabled using a liquid binder agent. In other examples, solidification may be enabled by temporary application of energy to the build material. In certain examples, fusing agents are applied to build material, wherein a fusing agent is a material that, when a suitable amount of energy is applied to a combination of build material and fuse agent, causes the build material to fuse and then to solidify upon cooling. In other examples, other build materials and other methods of solidification may be used. In certain examples, the build material includes paste material, slurry material or liquid material.

Examples of build materials for additive manufacturing include polymers, crystalline plastics, semi-crystalline plastics, polyethylene (PE), polylactic acid (PLA), acrylonitrile butadiene styrene (ABS), amorphous plastics, Polyvinyl Alcohol Plastic (PVA), Polyamide (e.g., nylon), thermo(setting) plastics, resins, transparent powders, colored powders, metal powder, ceramics powder such as for example glass particles, and/or a combination of at least two of these or other materials wherein such combination may include different particles each of different materials or different materials in a single compound particle. Examples of blended build materials include alumide, which may include a blend of aluminum and polyamide, and plastics/ceramics blends. There exist more build materials and blends of build materials that can be managed by an apparatus of this disclosure and that are not mentioned in this disclosure.

When using a single build material, the non-solidified build material surrounding the printed object tends to absorb solvents released from agents used to help create each layer of the object from the build material. This can lead to non-solidified build material particles, particularly in regions in close proximity to the printed object, to stick together, making it difficult to separate, or ‘decake’ or ‘depowder’, the printed object from build material that was not intended to be solidified. Furthermore, the absorption of solvents by non-solidified build material may make recycling of the non-solidified build material more challenging.

Furthermore, when using metal build materials and chemical binders, the printed objects, typically known as green parts, are not fused metal objects at this stage and the metal particles are held together just by a binder agent (e.g. after the binder agent has been cured). Green parts have to be sintered in a sintering furnace to transform them into high density and sintered metal objects. Green parts may, therefore, be somewhat fragile, which further complicates the decaking process, since decaking has to remove build material that does not form part of the green part, whilst at the same time without damaging the fragile green part. Simplifying the decaking process may lead to improved throughput and cheaper 3D printing of metal objects.

The aforementioned issues may be addressed by using a build material in areas of a layer corresponding to the object, and a filler material in the remaining areas of the layer. The build material and the filler material may have different properties, which may help with separation of the printed object from the surrounding material. For example, the filler material may have different absorption characteristics compared to the build material. In some examples, the build material and the filler material may have different particle sizes or other characteristics, so that they may be easily separated after use in the additive manufacturing process, for example by filtering. The filler material may be significantly cheaper than the build material, thus reducing the cost of an additive manufacturing process. For example, the filler material may be a ceramic powder and the build material may be a more expensive metal powder that provides a final object with the desired properties.

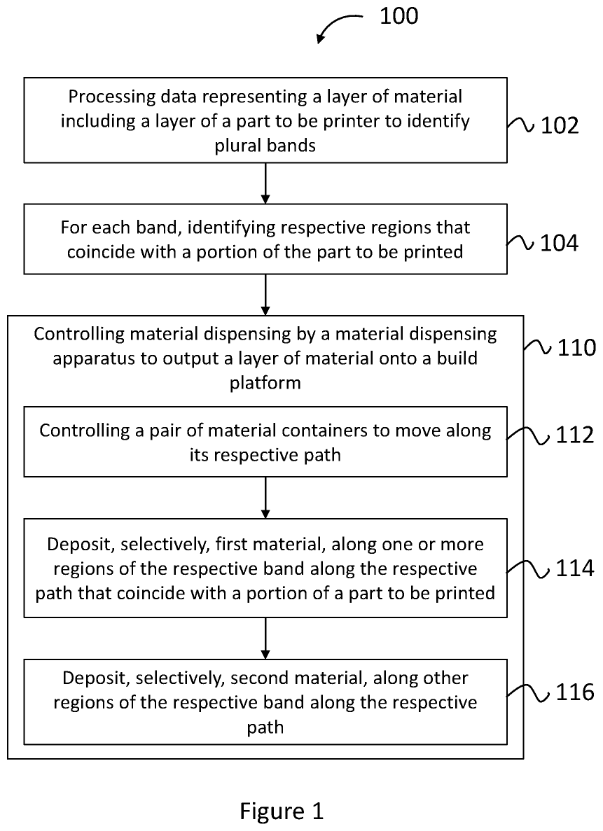

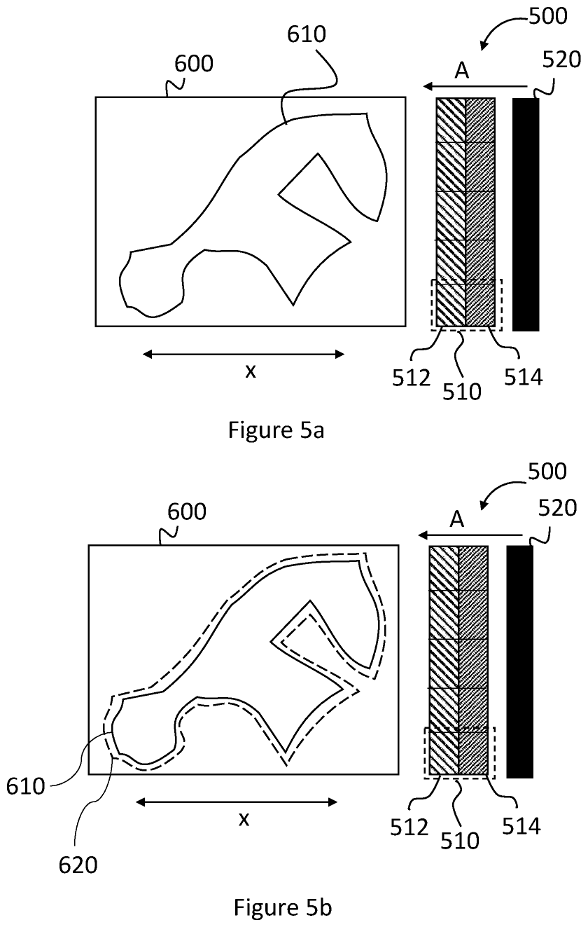

FIG. 1 is a flow diagram showing a method 100 according to an example. The method 100 comprises controlling 110 material dispensing by a material dispensing apparatus to output a layer of material onto a build platform. The material dispensing apparatus comprises a plurality of pairs of material containers (as described with reference to FIGS. 5a, 5b, 9 and 10), each pair of material containers movable along a path across the build platform, and comprising a first material container to dispense a first material and a second material container to dispense a second material, to output a band of material along the path, each pair of material containers being arranged with respect to each other pair of material containers to move along respective paths across the build platform to output respective bands of material forming a complete layer of material on the build platform.

The controlling (block 110) comprises controlling (block 112) each pair of material containers to move along its respective path and deposit (block 114), selectively, first material, along one or more regions of the respective band along the respective path that coincide with a portion of a part to be printed, and deposit (block 116), selectively, second material, along other regions of the respective band along the respective path. The controlling (block 110) may be by a controller comprised in the material dispensing apparatus or comprised in a system comprising the material dispensing apparatus. That is, the controlling (block 110) causes a respective pair of material containers to, at any one point along the band, dispense either the first material from the first material container, or the second material from the second material container. In other examples, the controlling (block 110) is based on a position of a build area, as opposed to a portion of a part to be printed. The build area encompasses the part to be printed, and may, in some examples, form a margin around the part to be printed. Such a margin may help to ensure that none of the second material unintentionally falls into a region of the part to be printed. In some examples, the plurality of pairs of material containers may be to move across the build platform in one pass to dispense a complete layer of material on the build platform.

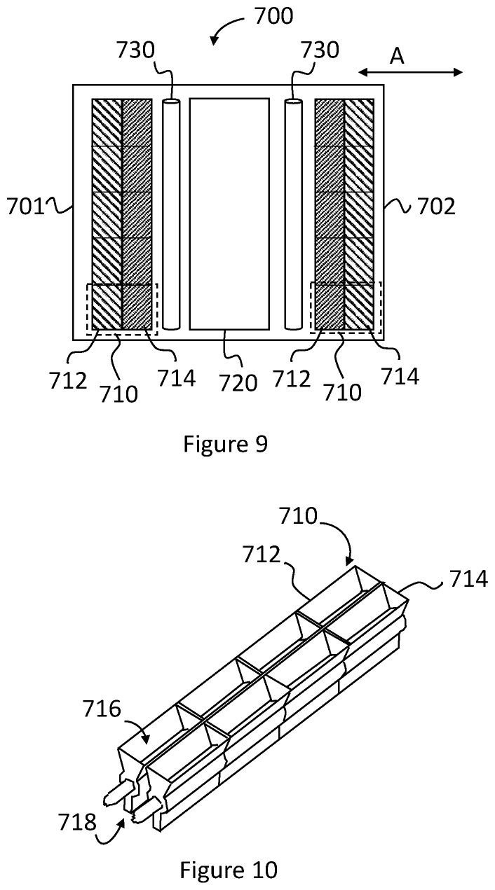

The controlling (block 112) may comprise depositing (block 114) the first material when an outlet of the first material container coincides with a portion of the part to be printed, and depositing (block 116) the second material when an outlet of the second material container does not coincide with a portion of the part to be printed. In some examples of the material dispensing apparatus (for example as described with reference to FIG. 9) a width of the respective outlets of the first and second material containers corresponds to a width of the respective band.

Such a method 100 forms a complete layer of material on the build platform, the layer comprising first material and second material. In an example, the first material is a build material to form a part to be printed, and the second material is a filler material to surround and support the build material.

In some examples (not shown in FIG. 1), the controlling (block 112) may comprise controlling each pair of material containers to move along its respective path and deposit, selectively, first material, along one or more regions of the respective band along the respective path that coincide with a portion of a build area and to deposit, selectively, second material, along other regions of the respective band along the respective path.

In some examples, as shown in FIG. 1, the method 100 may comprise processing data (block 102) representing a layer of material including a layer of a part to be printed to identify plural bands, each band corresponding with a pair of material containers. In such examples, the method 100 comprises, for each band, identifying (block 104) respective regions that coincide with a portion of the part to be printed. In other examples, the method 100 may comprise receiving such data, which is processed elsewhere. The processing data (block 102) may be performed by a processor, which may or may not be comprised in the material dispensing apparatus. For example, a controller to perform the controlling (block 110) may be to receive such processed data from a processor. In other examples (not shown in FIG. 1), the method 100 may comprise processing data representing a build area, dimensioned to encompass the layer of the part to be printed, to identify plural bands, each band corresponding with a part of material containers and, for each band, identifying (block 104) respective regions that coincide with a portion of the build area.

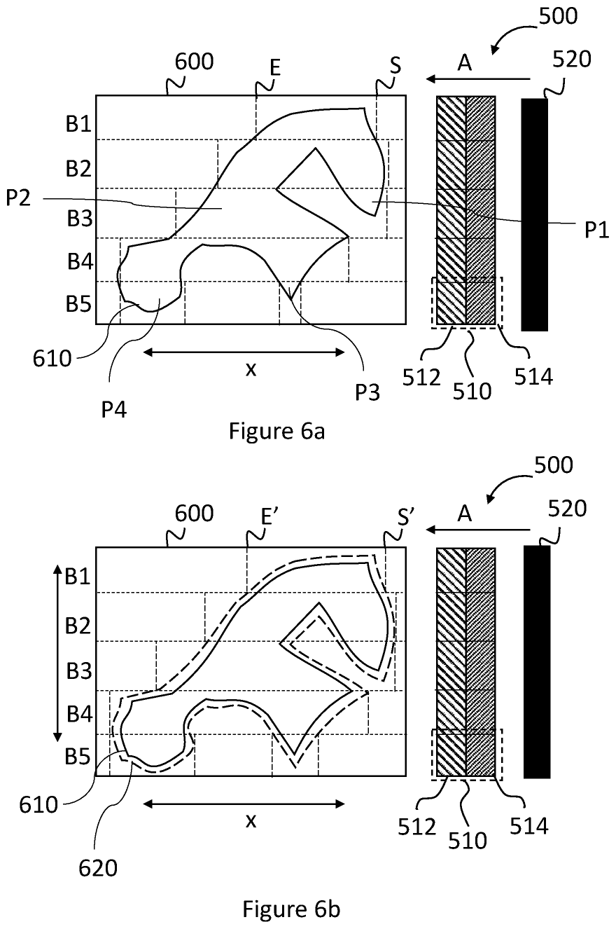

Each of the identified regions are rectangular, with start and end points that are perpendicular to the direction of travel of the material dispensing apparatus. The height of each region is determined by a width of outlets of a corresponding pair of material dispensers and is thus equal to a width of the respective band, and the length of each region is determined by the portion(s) of the part to be printed in the band, see for example FIGS. 6a and 6b.

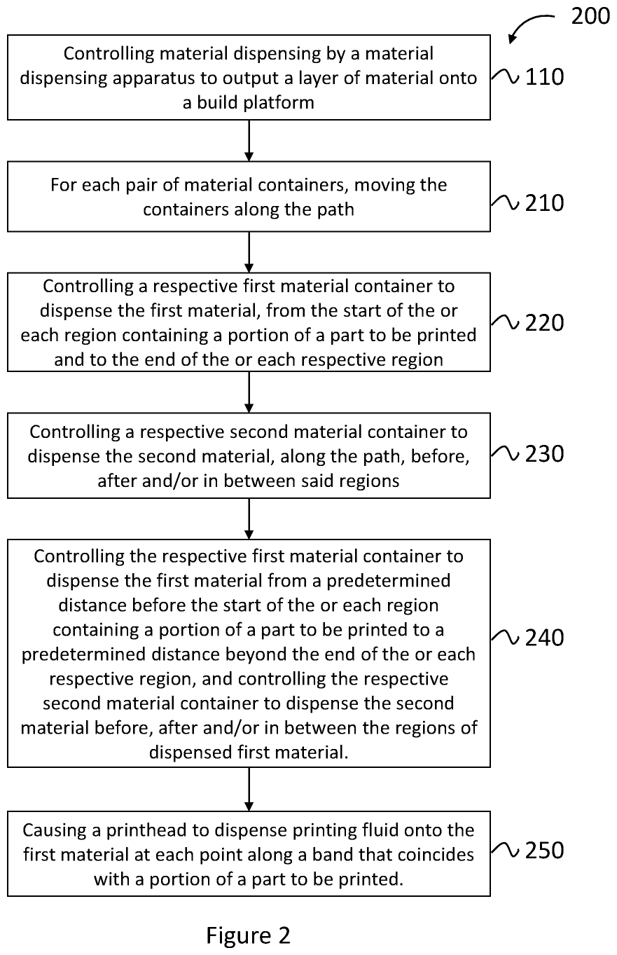

FIG. 2 is a flow diagram showing a method 200 according to an example. The method 200 comprises the controlling (block 110) of the method 100 described with reference to FIG. 1. Features shown in blocks 112, 114, 116 of the controlling (block 110) are not shown in FIG. 2 for clarity. In some examples (not shown), the method 200 comprises the processing data (block 102) and the identifying (block 104) respective regions of the method 100 described with reference to FIG. 1.

The method 200 comprises, for each pair of material containers of the material dispensing apparatus, moving (block 210) the containers along the path. For example, the plurality of pairs of material containers may be comprised in a carriage arranged to move across the build platform. A controller may be arranged to control movement of each pair of material containers along its respective path. The controller may be arranged to move all of the plurality of pairs of material containers simultaneously across the build platform.

The method 200 comprises controlling (block 220) a respective first material container to dispense the first material, from the start of the or each region containing a portion of a part to be printed and to the end of the or each respective region. That is, the controlling (block 220) causes the first material container in a respective pair of material containers to not dispense the first material before the start of a region containing a portion of a part to be printed and after the end of a region containing a portion of a part to be printed.

The method 200 comprises controlling (block 230) a respective second material container to dispense the second material, along the path before, after and/or in between said regions. That is, the controlling (block 230) causes the second material container in the respective pair of material containers to not dispense the second material in a region containing a portion of the part to be printed.

In some examples, as shown in FIG. 2, the method 200 comprises controlling (block 240) the first material container to dispense the first material from a predetermined distance before the start of the or each region containing a portion of a part to be printed to a predetermined distance beyond the end of the or each respective region, and controlling the second material container to dispense the second material before, after and/or in between the regions of dispensed first material. The “before” and “beyond” are in respect of the direction of movement of the material dispensing apparatus across the build platform. Such a method creates a margin of first material before and beyond each region of the part to be printed. Such a margin may help to ensure that none of the second material unintentionally falls into a region of the part to be printed.

The material dispensing apparatus may comprise one or more printheads positioned behind the plurality of pairs of material dispensers relative to the direction of motion of the material dispensing apparatus across the build platform when the material dispensing apparatus is dispensing material onto the build platform. The method 200 may comprise causing (block 250) the printhead or printheads to dispense printing liquid onto each point within each region in a band that coincides with a portion of the part to be printed. The printing liquid may be, for example, a binding agent to bind the first material together to help form the part to be printed.

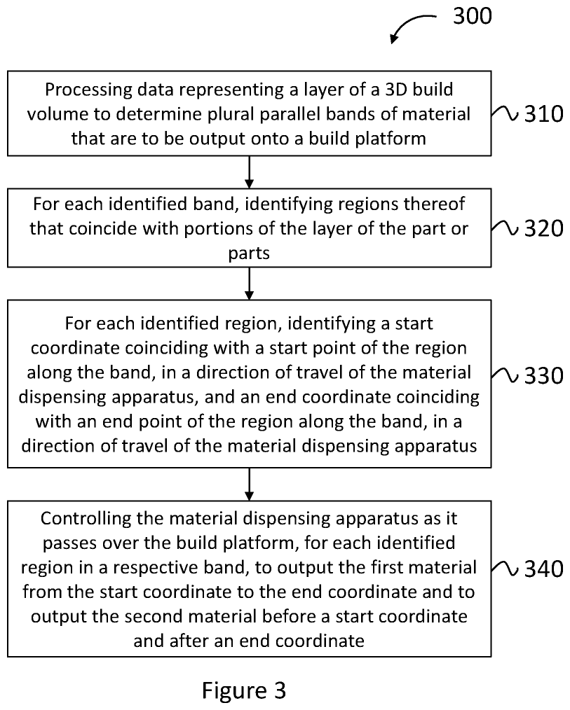

FIG. 3 is a flow diagram of a method 300 according to an example. The method 300 comprises processing data (block 310) representing a layer of a 3D build volume, to determine plural parallel bands of material that are to be output onto a build platform. The layer includes a layer of a part or parts to be printed by an additive manufacturing process. The bands of material are to be output onto the build platform by a material dispensing apparatus passing over the build platform, to form the layer of the 3D build volume. The material dispensing apparatus is to selectively output a first material or a second material (as described with reference to FIGS. 9 and 10).

The method 300 comprises, for each identified band, identifying (block 320) regions thereof that coincide with portions of the layer of the part or parts. For example, the identifying (block 320) may comprise determining the coordinates of a region in a band that coincide with the portions of the layer of the part of parts.

The method 300 comprises, for each identified region in a band, identifying (block 330) a start coordinate coinciding with a start point of the region along the band, in a direction of travel of the material dispensing apparatus, and an end coordinate coinciding with an end point of the region along the band, in a direction of travel of the material dispensing apparatus. For example, if the material dispensing apparatus is to travel from the left side of a build platform to a right side of the build platform to dispense material onto the build platform, the start point of a region is the left-most point of the region and the end point is the right-most point of the region.

The method 300 comprises controlling (block 340) the material dispensing apparatus as it passes over the build platform, for each identified region in a respective band, to output the first material from the start coordinate to the end coordinate and to output the second material before a start coordinate and after an end coordinate. In an example, two or more regions may overlap longitudinally in a band. For example, an end coordinate of a first region may be after a start coordinate of a second region, in a direction of travel of the material dispensing apparatus. In such examples, the controlling (block 340) comprises dispensing the first material from the first start point of the overlapping regions to the last end point of the overlapping regions, so that a single region of first material is dispensed to cover each of the overlapping regions (see, for example, band B2 in FIGS. 5a-8b).

In some examples (not shown), the method 300 comprises determining, for each identified region in a band, a material start coordinate and a material end coordinate. The material start coordinate is a predetermined distance before a respective identified start coordinate and the material end coordinate is a predetermined distance beyond a respective identified end coordinate. In such examples, the controlling (block 340) comprises controlling the material dispensing apparatus as it passes over the build platform, for each identified region in a respective band, to output the first material from the material start coordinate to the material end coordinate and to output the second material before a material start coordinate and after a material end coordinate.

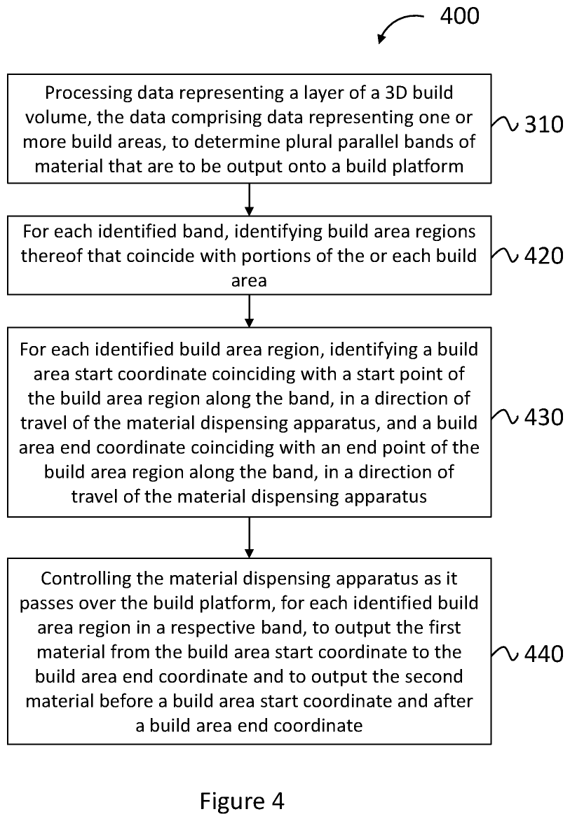

FIG. 4 is a flow diagram showing a method 400 according to an example. The method 400 is substantially similar to the method 300 described with reference to FIG. 3, and includes the features of blocks 310, 320, 330 and 340, which are not shown in FIG. 4, for clarity. In this example, the data representing the layer of the 3D build volume comprises data representing one or more build areas each encompassing a respective layer of a respective part to be printed. The method 400 comprises, for each identified band, identifying (block 420) build area regions thereof that coincide with portions of the or each build area. The method 400 comprises, for each identified build area region, identifying (block 430) a start coordinate coinciding with a build area start point of the build area region along the band, in a direction of travel of the material dispensing apparatus, and a build area end coordinate coinciding with an end point of the build area region along the band, in a direction of travel of the material dispensing apparatus. The method 400 comprises controlling (block 440) the material dispensing apparatus as it passes over the build platform, for each identified build area region in a respective band, to output the first material from the build area start coordinate to the build area end coordinate and to output the second material before a build area start coordinate and after a build area end coordinate.

In some examples (not shown), the method 300 or the method 400 comprise dividing each of the plurality of bands into longitudinal strips. Each of the strips has a width equal to a pixel of a printhead comprised in the material dispensing apparatus. For example, a pixel may be of a size corresponding to a nozzle of the printhead. The method 300, 400 may comprise, for each strip in a band, determining which pixels in the strip coincide with a portion of the layer of the part of parts, or a portion of the one or more build areas, and determining the coordinates of each pixel in the strip that represents a start or end coordinate of a portion of the layer of the part or parts, or a portion of the one or more build areas. The method 300, 400 may comprise storing, for each band, in respective arrays, all of the ranges that represent a portion of the layer of the part or parts, or a portion of the one or more build areas, and identifying ranges that overlap along the length of the band and storing overlapping ranges as an array. The method 300, 400 may comprise determining, for each array, a minimum start coordinate and a maximum end coordinate and generating data representing one or more rectangular cells, each of the one or more cells having: a width equal to a width of the band, a start coordinate corresponding to a respective minimum start coordinate, and an end coordinate corresponding to a respective maximum end coordinate. The method 300, 400 may comprise controlling the material dispensing apparatus as it passes over the build platform, for each respective band, to output the first material in the one or more cells and to output the second material outside the one or more cells to form a complete band of material. The method 300, 400 may comprise providing a margin of first material around the part or parts to be printed, for example by basing the method 400 on one or more build areas providing a margin around the part or parts to be printed or by the method 300 comprising adjusting, for each region in each band, the start and end coordinates respectively to provide a margin of first material before and beyond each region in a band.

In some examples, in which the material dispensing apparatus comprises a printhead, the controlling comprises causing the printhead to dispense printing liquid onto the first material at each pixel along each longitudinal strip that coincides with a portion of the part or parts to be printed.

FIGS. 5a to 8b show schematically, the implementation of methods according to an example, for example the methods 100, 200, 300, 400 described with reference to FIGS. 1-4. FIGS. 5a-8b show the methods being implemented by a material dispensing apparatus 500 dispensing first and second materials onto a build platform 600. The material dispensing apparatus 500 will be described in more detail with reference to FIGS. 9 and 10. In these examples, the material dispensing apparatus 500 is movable across the build platform 600 in the direction denoted by arrow A, parallel to an x-direction across the build platform 600. The material dispensing apparatus comprises a plurality of pairs of material dispensers 510, each pair of material containers being movable along a path across the build platform 600 in the x-direction, and comprising a first material container 512 to dispense a first material and a second material container 514 to dispense a second material, to output a band of material along the path. In these examples, each pair of material containers 510 is arranged with respect to each other pair of material containers to move along respective paths across the build platform 600 to output respective bands of material forming a complete layer of material on the build platform 600. In these examples, the material dispensing apparatus 500 comprises a printhead 520 arranged to follow the plurality of pairs of material containers 510 in a direction of travel A of the material dispensing apparatus 500. In some examples (not shown), the material dispensing apparatus 500 comprises a second plurality of pairs of material dispensers 510 (as described with reference to FIG. 9). In FIGS. 5a-8b, the material dispensing apparatus comprises five pairs of material containers 510. In other examples, the material dispensing apparatus may comprise fewer or more than five pairs of material containers 510.

FIGS. 5a, 6a, 7a, 8a show the implementation of a method according to an example and based on data representing a layer of a part to be printed 610. FIGS. 5b, 6b, 7b, 8b show the implementation of a method according to an example and based on data representing a layer of a part to be printed 610 and a build area 620 encompassing the layer of the part to be printed 610.

FIG. 5a shows a layer of a part to be printed 610 superimposed onto the build platform 600 and FIG. 5b shows the layer of the part to be printed 610 and an encompassing build area 620 superimposed onto the build platform 600. In some examples, the build area 620 forms a perimeter at a predetermined distance around the layer of the part to be printed 610.

FIG. 6a shows the build platform 600 having been divided into plural parallel bands, B1-B5 (block 102 of FIG. 1 and block 310 of FIG. 3 and FIG. 4). The bands B1-B5 correspond in width to outlets of the corresponding pair of material dispensers. For each band, start and end coordinates, S, E, have been identified for each region of the band B1-B5 that coincides with a portion of the layer of the part to be printed 610 (block 330 of FIG. 3). The band B3 contains two portions P1, P2 of the layer of the part to be printed 610. The two portions P1, P2 overlap longitudinally along the length of the band B3, so that a single region has been identified by the method 100, 200, 300, 400, which encompasses both of the longitudinally overlapping portions P1, P2. In contrast, the band B5 contains two portions P3, P4 of the layer of the part to be printed 610 that do not overlap longitudinally along the length of the band B5, so two separate regions have been identified by the method 100, 200, 300, 400, one region for each portion P3, P4. FIG. 6b shows the build platform 600 having been divided into plural parallel bands B1-B5, as in FIG. 6b. For each band B1-B5 in FIG. 6b, start and end coordinates S′, E′ have been identified for each region of the band B1-B5 that coincides with a portion of the build area 620. As can be seen by comparing FIG. 6a to FIG. 6b, the start and end coordinates S′, E′ for each region in FIG. 6b are further apart from one another compared to the start and end coordinates S, E of the corresponding region in FIG. 6a due to the build area 620 providing a margin around the layer of the part to be printed 610.

In examples, as shown in FIGS. 6a and 6b, each of the identified regions are rectangular, with start and end coordinates S, E (or S′, E′) that are perpendicular to the direction of travel of the material dispensing apparatus 500. The height of each rectangle is determined by a width of outlets of a corresponding pair of material dispensers 510, and the length of each rectangle is determined by the part to be printed 610 and/or the build area 620. Such an arrangement may provide a good balance between the cost of the material dispensing apparatus 500, which is dependent on the number of pairs of material containers 510, and the material dispensing resolution of the material dispensing apparatus 500, which is dependent on the number and size of the pairs of material containers.

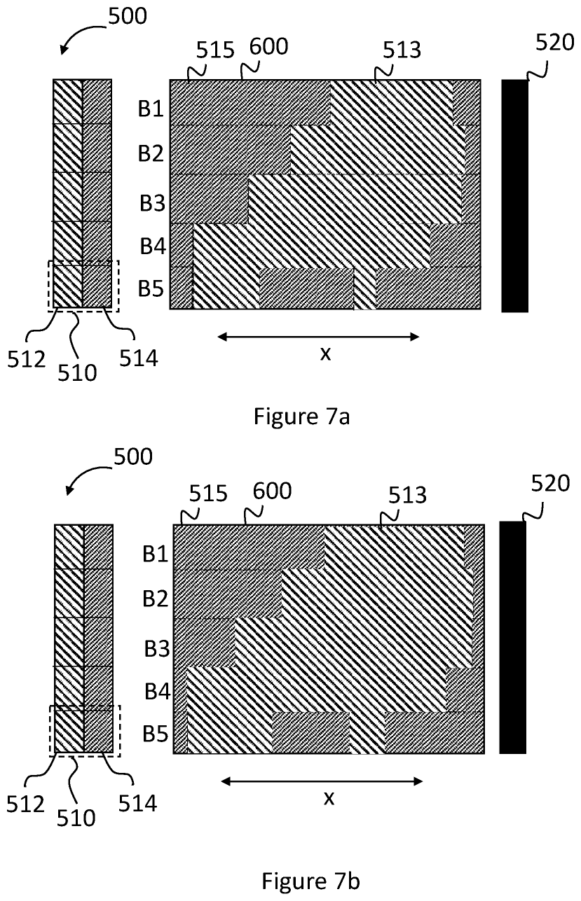

FIG. 7a shows the build platform 600 after the material dispensing apparatus 500 has moved across the build platform 600 and dispensed the first and second materials 513, 515 based on the start and end coordinates S, E shown in FIG. 6a. The first material 513 has been dispensed in each region of each band B1-B5 coinciding with the layer of the part to be printed 610. That is, the first material 513 has been dispensed, for each identified region, from the start coordinate S to the end coordinate E and the second material 515 has been dispensed before a start coordinate S and after an end coordinate E. FIG. 7b shows the build platform 600 after the material dispending apparatus 500 has moved across the build platform 600 and dispensed the first and second materials 513, 515 based on the start and end coordinates S′, E′ shown in FIG. 6b, in the same way as described with reference to FIG. 7a.

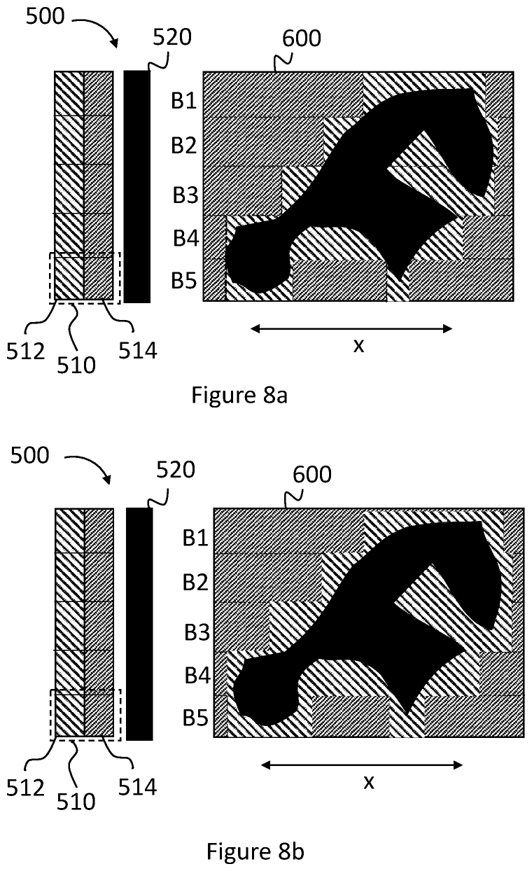

FIGS. 8a and 8b shows the build platform after the printhead 520 of the material dispensing apparatus 500 has dispensed printing liquid onto the layer of material at each point in each region in each band B1-B5 that coincides with a point in the layer of the part to be printed 610 (block 250 of FIG. 2). In FIG. 8b, processing of data representing a build area 620 encompassing the layer of the part to be printed 610 has resulted in a margin of the first material 513 around the printed printing liquid. This can help to accommodate a lower resolution of material dispensing from the material containers 510 compared to the resolution of the printhead 520 when dispensing printing liquid.

In this example, the printhead 520 is comprised on a different carriage to the plurality of pairs of material containers 510. In other examples, the printhead 520 may be comprised in the same carriage as the plurality of pairs of material containers 510 and may begin to dispense printing liquid onto the layer of material before the complete layer of material has been dispensed by the material containers.

FIG. 9 is a schematic plan view of an example material dispensing apparatus 700 of a 3D printing system that may be suitable for carrying out the aforementioned methods, for example the methods 100, 200, 300, 400 described with reference to FIGS. 1-4. In use, the material dispensing apparatus 700 moves across a build platform of the 3D printing system in the directions denoted by arrow A to dispense a layer of material on the build platform. The material dispensing apparatus 700 comprises a plurality of pairs of material containers 710. Each pair of material containers 710 is movable along a path across the build platform, to output a band of material along the path.

Each pair of material containers 710 comprises a first material container 712 to dispense a first material and a second material 714 container to dispense a second material. Each pair of material containers 710 is arranged with respect to each other pair of material containers 710 to move along respective paths across the build platform to output respective bands of material forming a complete layer of material on the build platform. Such an arrangement covers the full width of the build platform so that a single pass of the material dispensing apparatus 700 over the build platform may form a complete layer material dispensed from the plurality of pairs of material containers 710. In use, one of the first material container 712 and the second material container 714 in each pair of material containers 710 contains a build material, and the other of first material container 712 and the second material container 714 contains a filler material.

As shown in the example material dispensing apparatus 700 of FIG. 9, the material dispensing apparatus 700 comprises a second plurality of pairs of material containers 710 arranged on an opposite side of the material dispensing apparatus 700 compared to the plurality of pairs of material containers 710. Such an arrangement enables the material dispensing apparatus 700 to dispense the first and second materials when the material dispensing apparatus 700 moves in either direction denoted by arrow A across the build platform. That is, each of the plurality of pairs of material containers 710 is arranged to dispense material onto the build platform as the material dispensing apparatus 700 moves across the build platform in a first direction (with edge 701 as the leading edge), and each of the second plurality of pairs of material containers 710 is arranged to dispense material onto the build platform as the material dispensing apparatus 700 moves across the build platform in a second direction (with edge 702 as the leading edge).

In the example of FIG. 9, one of the two pluralities of pairs of material containers 710 is active (and thus capable of depositing material) in a pass of the material dispensing apparatus 700 over a build platform. Which of the pluralities is active is dependent on the direction of travel of the material dispensing apparatus 700. More specifically, the active plurality is the plurality that is adjacent the respective leading edge (701 or 702 dependent on the direction of travel of the material dispensing apparatus).

In some examples, the material dispensing apparatus 700 is movable across the build platform in a direction perpendicular to direction A. In some examples, the material dispensing apparatus 700 may be oriented relative to the build platform to be movable across the build platform in a direction perpendicular to direction A to dispense material to form a complete layer of material across the build platform.

The material dispensing apparatus 700 may comprise at least one printhead 720 arranged to, in use, deposit a printing liquid, such as a binding agent, fusing agent, or ink-type formulation, onto the layer of material. The printhead 720 may be arranged to deposit printing liquid onto a layer of material dispensed by the plurality of pairs of material containers 710 to form a shape corresponding to a layer of one or more parts to be printed. In the example shown in FIG. 9, the printhead 720 is arranged between the two pluralities of pairs of material containers 710 such that the printhead 720 follows the plurality of pairs of material containers 710 as the material dispensing apparatus 700 moves across the build platform in a particular direction A. In another example, the printhead 720 may be located on a separate apparatus or carriage compared to the pluralities of pairs of material containers 710. In an example, the printhead may be arranged to move across the build platform in a direction perpendicular to the direction of movement A of the material dispensing apparatus 700.

The material dispensing apparatus 700 may comprise one or more recoaters 730 to, in use, level out and compact the layer of material dispensed by the plurality of pairs of material containers 710. For example, the recoater 730 may comprise a roller and/or a blade. In the example shown in FIG. 9, the material dispensing apparatus comprises two recoaters 730 positioned between the printhead 720 and a respective one of the plurality of pairs of material containers 710. Such an arrangement allows a respective one of the recoaters 730 to level out and compact a layer of material before the printhead 720 dispenses printing liquid onto the layer of material, irrespective of the direction of travel A of the material dispensing apparatus 700 across the build platform. In another example, the recoater(s) 730 may be located on a separate apparatus or carriage compared to the pluralities of pairs of material containers 710. In an example, the recoater(s) 730 may be arranged to move across the build platform in a direction perpendicular to the direction of movement of the material dispensing apparatus 700.

FIG. 10 shows a schematic isometric view of a plurality of pairs of material containers 710 for use in the material dispensing apparatus 700 of FIG. 9. In the example shown in FIG. 10, the first and second material containers 712, 714 of each pair of material containers 710 are arranged in respective adjacent rows. Whilst four pairs of material containers 710 are shown, in other examples, the number of pairs of material containers 710 may vary, depending on the desired balance between printing efficiency and precision. In further examples, the material dispensing apparatus 700 comprises, for example, trios of material containers rather than pairs of material containers 710.

Each of the first material containers 712 is a discrete volume arranged to contain an amount of first material, and each of the second material containers 714 is a discrete volume arranged to contain an amount of second, different material. The first material may be a material to form a final printed part, so-called a build material, and the second material may be a material to use as a filler to support the printed part, so-called a filler material, or vice versa. The first and second materials have properties appropriate to their corresponding function. As an example, the first material may be a metallic material to form the printed part and the second material may be a non-metallic material to act as a filler material.

Each material container 712, 714 has a holding volume 716 arranged to hold a discrete quantity of material. The holding volume 716 of each container is funnel-shaped. Each material container also has an outlet 718 through which the respective material is dispensed onto said build platform from the respective holding volume 716. Each outlet 718 has a corresponding outlet mechanism positioned within the outlet 718 to control the flow of material through the outlet 718. For example, the outlet mechanism may be selectively switchable between an open position, in which material can flow out of the material container 712, 714 through the outlet 718, and a closed position, in which material is prohibited from flowing out of the material container 712, 714 through the outlet 718. In some examples, the material container 712, 714 may have at least one of the following mechanisms either in place of or in addition to the aforementioned outlet mechanism to deposit material: a moving sieve system; a screw feeder; a depositing slot; a pouring nozzle; a blown powder mechanism. In one example, a material container 712, 714 may have a screw feeder in combination with a pouring nozzle.

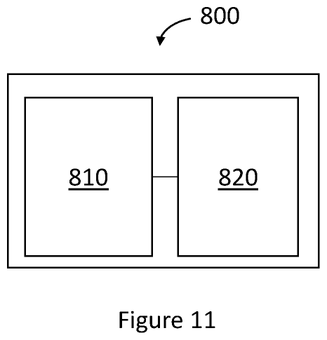

FIG. 11 is a schematic drawing of a system 800 according to an example. The system 800 may be a printing system such as a 3-D printing system. The system 800 comprises a material dispensing apparatus 810 such as the material dispensing apparatus 700 described with reference to FIG. 9. The material dispensing apparatus 810 comprises a plurality of pairs of material containers (not shown), each pair of material containers movable along a path across a build platform, and comprising a first material container to dispense a first material and a second material container to dispense a second material, to output a band of material along the path, each pair of material containers being arranged with respect to each other pair of material containers to move along respective paths across the build platform to output respective bands of material forming a complete layer of material on the build platform. In some examples, the system 800 may comprise a second material dispensing apparatus 700. The second material dispensing apparatus 700 may be to move across the build platform in a direction perpendicular to the direction of movement of the other material dispensing apparatus 700. In some examples, the system comprises the build platform (not shown).

The system 800 comprises a controller 810 to control each pair of material containers in the or each material dispensing apparatus 700 to move along its respective path and deposit, selectively, first material, along one or more regions of the respective band along the respective path that coincide with a portion of a part to be printed, and second material, along other regions of the respective band along the respective path. In an example, the controller 820 may be to control a printhead (not shown) to deposit printing liquid onto the layer of material to coincide with the part to be printed. The printhead may be comprised in the material dispensing apparatus 810. In an example, the controller 810 comprises a programmed processor to read and execute instructions, for example instructions to perform a method according to an example. The controller 810 may comprise a memory to store the instructions read and executed by the processor, for example on a non-transitory computer-readable medium. In some examples, the processor may be to select a material dispensing apparatus 700 from a first and second material dispensing apparatus in the system 800, the two apparatus to move across the build platform in directions perpendicular to one another, based on which of the two apparatus provides a closer fit around the part to be printed. Such a selection may help the system 800 to be more economic with the first material. In other examples, the controller may control both such a first and second material dispensing apparatus 700 to dispense material onto a build platform. In some examples, controller 810 may control the plurality of pairs of material containers may be to move across the build platform in one pass to dispense a complete layer of material on the build platform.

In another example, the controller 820 may be comprised in a computer connected to the system 800. For example, the controller 820 may be to send instructions to the system 800.

The preceding description has been presented to illustrate and describe examples of the principles described. This description is not intended to be exhaustive or to limit these principles to any precise form disclosed. Many modifications and variations are possible in light of the above teaching. It is to be understood that any feature described in relation to any one example may be used alone, or in combination with other features described, and may also be used in combination with any features of any other of the examples, or any combination of any other of the examples.

What is claimed is:

1. A method, comprising:
controlling material dispensing by a material dispensing apparatus to output a layer of material onto a build platform,
the material dispensing apparatus comprising a plurality of pairs of material containers, each pair of material containers movable along a path across the build platform, and comprising a first material container to dispense a first material and a second material container to dispense a second material, to output a band of material along the path, each pair of material containers being arranged with respect to each other pair of material containers to move along respective paths across the build platform to output respective bands of material forming a complete layer of material on the build platform,
wherein the controlling comprises controlling each pair of material containers to move along its respective path and deposit, selectively, first material, along one or more regions of the respective band along the respective path that coincide with a portion of a part to be printed, and deposit, selectively, second material, along other regions of the respective band along the respective path.

2. A method according to claim 1, comprising, processing data representing a layer of material including a layer of a part to be printed to identify plural bands, each band corresponding with a pair of material containers, and, for each band, to identify respective regions that coincide with a portion of the part to be printed.

3. A method according to claim 1, comprising, for each pair of material containers, moving the containers along the path and controlling a respective first material container to dispense the first material, from the start of the or each region containing a portion of a part to be printed and to the end of the or each respective region, and a respective second material container to dispense the second material, along the path before, after and/or in between said regions.

4. A method according to claim 3, comprising controlling the respective first material container to dispense the first material from a predetermined distance before the start of the or each region containing a portion of a part to be printed to a predetermined distance beyond the end of the or each respective region, and controlling the respective second material container to dispense the second material before, after and/or in between the regions of dispensed first material.

5. A method according to claim 1, comprising controlling each pair of material containers to move in one pass along its respective path and deposit, selectively, first material when an outlet of the respective first material container coincides with a portion of the part to be printed, and second material when an outlet of the respective second material container does not coincide with a portion of the part to be printed.

6. A method according to claim 5, wherein a width of the respective outlets of the first and second material containers corresponds to a width of the respective band.

7. A method according to claim 1, wherein the controlling comprises controlling each pair of material containers to move in one pass along its respective path and deposit, selectively, first material, along one or more regions of the respective band along the respective path that coincide with a portion of a build area, and second material, along other regions of the respective band along the respective path, wherein the build area is dimensioned to encompass the portions of the part to be printed to create a margin around a layer of the part to be printed.

8. A method according to claim 1, wherein the first material is a build material and the second material is a filler material.

9. A method according to claim 1, wherein the material dispensing apparatus comprises a printhead positioned behind the plurality of pairs of material dispensers relative to the direction of motion of the material dispensing apparatus across the build platform when the material dispensing apparatus is dispensing material onto the build platform, and
wherein the method comprises causing the printhead to dispense printing liquid onto the first material at each point in the band that coincides with a portion of the part to be printed.

10. A method comprising:
processing data representing a layer of a 3D build volume, including a layer of a part or parts to be printed by an additive manufacturing process, to determine plural parallel bands of material that are to be output onto a build platform, by a material dispensing apparatus passing over the build platform, to form the layer of the 3D build volume, the material dispensing apparatus being to selectively output a first material or a second material;
for each identified band, identifying regions thereof that coincide with portions of the layer of the part or parts;
for each identified region in a band, identifying a start coordinate coinciding with a start point of the region along the band, in a direction of travel of the material dispensing apparatus, and an end coordinate coinciding with an end point of the region along the band, in a direction of travel of the material dispensing apparatus;
controlling the material dispensing apparatus as it passes over the build platform, for each identified region in a respective band, to output the first material from the start coordinate to the end coordinate and to output the second material before a start coordinate and after an end coordinate.

11. A method according to claim 10, comprising:
determining, for each identified region in a band, a material start coordinate, the material start coordinate being a predetermined distance before a respective identified start coordinate, and a material end coordinate, the material end coordinate being a predetermined distance beyond a respective identified end coordinate; and
controlling the material dispensing apparatus as it passes over the build platform, for each identified region in a respective band, to output the first material from the material start coordinate to the material end coordinate and to output the second material before a material start coordinate and after a material end coordinate.

12. A method according to claim 10, wherein the data representing the layer of the 3D build volume comprises data representing one or more build areas each encompassing a respective layer of a respective part to be printed, and wherein,
the method comprising:
for each identified band, identifying build area regions thereof that coincide with portions of the or each build area;
for each identified build area region, identifying a build area start coordinate coinciding with a start point of the build area region along the band, in a direction of travel of the material dispensing apparatus, and a build area end coordinate coinciding with an end point of the build area region along the band, in a direction of travel of the material dispensing apparatus; and
controlling the material dispensing apparatus as it passes over the build platform, for each identified build area region in a respective band, to output the first material from the start coordinate to the end coordinate and to output the second material before a start coordinate and after an end coordinate.

13. A method according to claim 10, comprising:
dividing each of the plurality of bands into longitudinal strips, each strip having a width equal to a pixel of a printhead comprised in the material dispensing apparatus;
for each strip in a band, determining which pixels in the strip coincide with a portion of the layer of the part or parts;
determining the coordinates of each pixel in the strip that represents a start or end coordinate of a portion of the layer of the part or parts;
storing, for each band, in respective arrays, all of the ranges that represent a portion of the layer of the part or parts by their coordinates;
identifying ranges that overlap along the length of the band and storing overlapping ranges as a single array;
determining, for each array, a minimum start coordinate and a maximum end coordinate;
generating data representing one or more rectangular cells, each of the one or more cells having a width equal to a width of the band, a start coordinate corresponding to a respective minimum start coordinate, and an end coordinate corresponding to a respective maximum end coordinate; and
controlling the material dispensing apparatus as it passes over the build platform, for each respective band, to output the first material in the one or more cells and to output the second material outside the one or more cells to form a complete band of material.

14. A method according to claim 13, wherein the material dispensing apparatus comprises a printhead, and
wherein the controlling comprises causing the printhead to dispense printing liquid onto the first material at each pixel along each longitudinal strip that coincides with a portion of the part or parts to be printed.

15. An additive manufacturing system comprising:
a material dispensing apparatus comprising a plurality of pairs of material containers, each pair of material containers movable along a path across a build platform, and comprising a first material container to dispense a first material and a second material container to dispense a second material, to output a band of material along the path, each pair of material containers being arranged with respect to each other pair of material containers to move along respective paths across the build platform to output respective bands of material forming a complete layer of material on the build platform, and
a controller to control each pair of material containers to move along its respective path and deposit, selectively, first material, along one or more regions of the respective band along the respective path that coincide with a portion of a part to be printed, and second material, along other regions of the respective band along the respective path.
